(19) United States
(12) Patent Application Publication
(10) Pub. No.: US 2014/0297618 A1
(43) Pub. Date: Oct. 2, 2014

(54) METHOD AND SYSTEM FOR AUTOMATICALLY SELECTING TAGS FOR ONLINE CONTENT

(71) Applicant: Corinne Elizabeth Sherman, Sunnyvale, CA (US)

(72) Inventor: Corinne Elizabeth Sherman, Sunnyvale, CA (US)

(21) Appl. No.: 13/972,580

(22) Filed: Aug. 21, 2013

Related U.S. Application Data
(60) Provisional application No. 61/806,325, filed on Mar. 28, 2013.

(51) Int. Cl. G06F 17/30

(52) U.S. Cl. CPC G06F 17/30867
USPC 707/710

(57) ABSTRACT

Via social networks, a user may publish a comment about published content and include a link to the published content. The comment may include one or more keywords designated as such using a symbol such as “#” or “@”. Systems and methods described herein automatically, without human intervention, add tags to a publication of the link when the user selects a share widget on a webpage where content is published. The tags may describe the content, a good or service being sold, the provider of the content, or some other aspect.

This application claims the priority benefit of U.S. Provisional Application No. 61/806,325, filed Mar. 28, 2013, which is incorporated herein by reference.

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright eBay, Inc. 2013, All Rights Reserved.

### TECHNICAL FIELD

The present application relates generally to the technical field of network communications and, in one specific example, to a method and system for automatically selecting tags for online content.

### BACKGROUND

Online content may be “tagged” with one or more keywords. The keywords may be used by search engines, social networks, content providers, online merchants, or other entities to identify and distribute content. In some instances, to create a hashtag, keywords are preceded by a hash mark (“#”) to indicate that the immediate word or phrase is intended to be a keyword. For example, the keyword “shoes” may be made into the hashtag “#shoes”.

Keywords are usually manually added to content by content providers. In some instances, words within the content may be automatically identified as potential keywords based, for example, on the frequency of words included in the content. In some instances, a word cloud may be created from content based on word frequency. Some words may then be automatically converted to hashtags by adding a hash mark to the beginning of the word. In other instances, keywords, phrases or symbols may be identified and used as content.

### BRIEF DESCRIPTION OF THE DRAWINGS

Some embodiments are illustrated by way of example and not limitation in the figures of the accompanying drawings in which:

FIG. 1 is a network diagram depicting a client-server system, within which one example embodiment may be deployed.

FIG. 2 is a block diagram of an example system, according to various embodiments.

FIG. 3 is a flowchart illustrating an example method, according to various embodiments.

FIG. 4 is a diagrammatic representation of machine in the example form of a computer system within which a set of instructions, for causing the machine to perform any one or more of the methodologies discussed herein, may be executed.

### DETAILED DESCRIPTION

Example methods and systems to automatically select tags for online content are described. In the following description, for purposes of explanation, numerous specific details are set forth in order to provide a thorough understanding of example embodiments. It will be evident, however, to one skilled in the art that the present invention may be practiced without these specific details.

The use of tags to identify online content may allow content providers and content consumers to access or share online content more easily. Hashtags, identified by the hash sign “#”, are particularly useful for identifying content shared via social platforms. Other types of tags may be designated as such by being preceded by the “@” character. In some instances, the use of hashtags may increase traffic to online publication websites, ecommerce websites, social media websites, and the like by, for example, causing the content to be more readily identified by search engines that then rank the content having hashtags higher than content bereft of hashtags.

Online content may be distributed between users when one or more users opt to “share” the content. In embodiments, a content page includes the content and a number of options that can be selected by the user. The options may include an option to send a link to the content page in an electronic message (e.g., email, text message, private message within a social network), or to share a link to the content via a social network. Social networks include, but are not limited to Twitter, Facebook, LinkedIn, Pinterest, Instagram, Blogging sites, email hosting services, Reddit, Stumbleupon, Tumblr, YouTube, VK, meet-up sites, dating sites, image- or video-sharing sites, and other websites where users can post content or replies to content.

An online marketplace is a website or mobile application where a user may buy or sell goods or services (referred to collectively as “items”) from a provider of the online marketplace or other users of the online marketplace. The goods or services are described in a published listing. The online marketplace may catalogue items for sale to group listing describing similar items together. The catalogue may provide a single, standard description of fungible items and include at least a portion of the various properties or characteristics.

The online marketplace publishes online content in the form of the listing in a view item page or another webpage. In embodiments, the view item page includes the description of the good or service and a number of options that can be selected by the user. The options may include an option to purchase or bid on the item, an option to watch the item, an option to send a link to the listing in an electronic message (e.g., email, text message, private message within a social network), or to share a link to the listing via a social network.

Via social networks, a user may publish a comment about a published listing and include a link to the published listing. In online marketplaces, the user may be a buyer, a seller, or a visitor to the online marketplace. The comment may include one or more keywords. In some social networks (including Twitter), keywords may be designated as hashtags or other tags using a symbol such as “#” or “@”, respectively. A keyword using “@” may correspond to a particular user, place, or thing which is related to the online content. Further, a keyword for the online content could be the price or indicate a discount from the price such as a “percent off.” Therefore, a keyword could be designated using the “$” symbol or “%” symbol.

Systems and methods described herein automatically, without human intervention, add keywords to a publication of the link when the user selects a share button on the view item page or another webpage published by the online marketplace or another content provider. The share button may be specific to a particular social network or may allow a user to select a social network via another interface (e.g., a pop-up window). Depending on the social network selected, the system generates a comment that can be published by the selected social network. The comment is formatted according to the requirements of the selected social network. The comment includes a link to the view item page (or other page from which the user chooses the share button) and one or more keywords that describe the listing. The keywords may describe the good or service being sold, the online marketplace, the seller, the terms of the sale, product or category information, or some other aspect. The user may be allowed to edit the comment by, for example, adding or removing text, links, keywords, or other content. The user publishes the comment via the social network by confirming a desire to publish the comment.

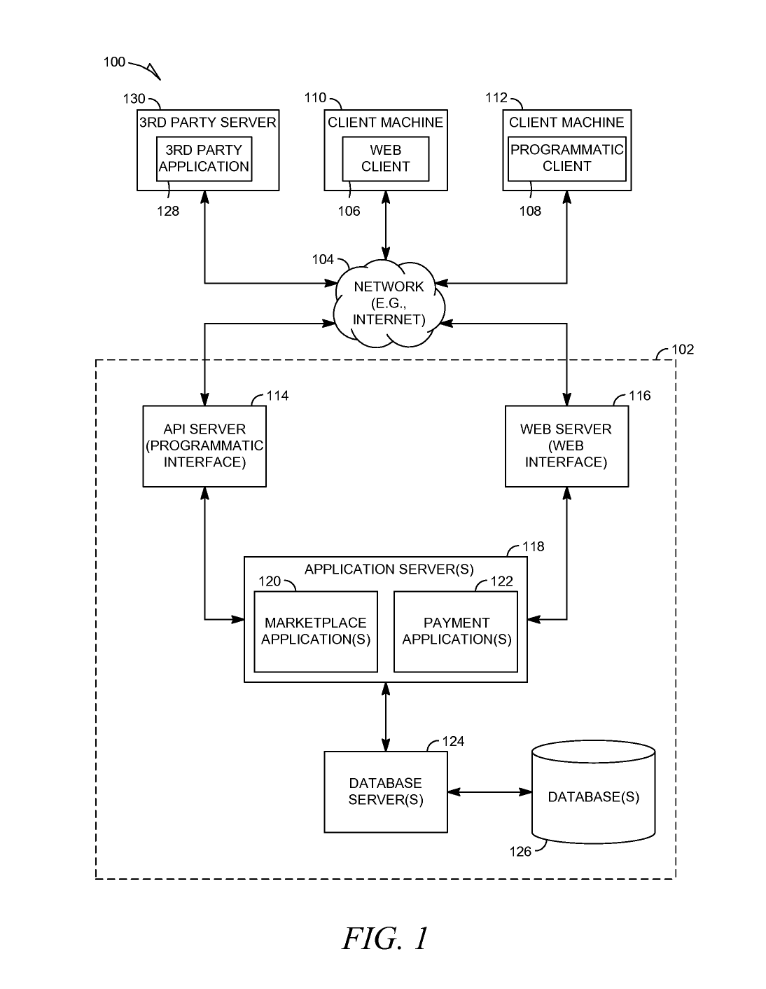

FIG. 1 is a network diagram depicting a client-server system 100, within which one example embodiment may be deployed. A networked system 102, in the example forms of a network-based marketplace or publication system, provides server-side functionality, via a network 104 (e.g., the Internet or Wide Area Network (WAN)) to one or more clients. FIG. 1 illustrates, for example, a web client 106 (e.g., a browser), and a programmatic client 108 executing on respective client machines 110 and 112.

An Application Program Interface (API) server 114 and a web server 116 are coupled to, and provide programmatic and web interfaces respectively to, one or more application servers 118. The application servers 118 host one or more marketplace applications 120 and payment applications 122. The application servers 118 are, in turn, shown to be coupled to one or more databases servers 124 that facilitate access to one or more databases 126.

The marketplace applications 120 may provide a number of marketplace functions and services to users that access the networked system 102. The payment applications 122 may likewise provide a number of payment services and functions to users. The payment applications 122 may allow users to accumulate value (e.g., in a commercial currency, such as the U.S. dollar, or a proprietary currency, such as “points”) in accounts, and then later to redeem the accumulated value for products (e.g., goods or services) that are made available via the marketplace applications 120. While the marketplace and payment applications 120 and 122 are shown in FIG. 1 to both form part of the networked system 102, it will be appreciated that, in alternative embodiments, the payment applications 122 may form part of a payment service that is separate and distinct from the networked system 102.

Further, while the system 100 shown in FIG. 1 employs a client-server architecture, the present invention is of course not limited to such an architecture, and could equally well find application in a distributed, or peer-to-peer, architecture system, for example. The various marketplace and payment applications 120 and 122 could also be implemented as standalone software programs, which do not necessarily have networking capabilities.

The web client 106 accesses the various marketplace and payment applications 120 and 122 via the web interface supported by the web server 116. Similarly, the programmatic client 108 accesses the various services and functions provided by the marketplace and payment applications 120 and 122 via the programmatic interface provided by the API server 114. The programmatic client 108 may, for example, be a seller application (e.g., the TurboLister application developed by eBay Inc., of San Jose, Calif.) to enable sellers to author and manage listings on the networked system 102 in an off-line manner, and to perform batch-mode communications between the programmatic client 108 and the networked system 102.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more promotional, marketplace, social network, or payment functions that are supported by the relevant applications of the networked system 102.

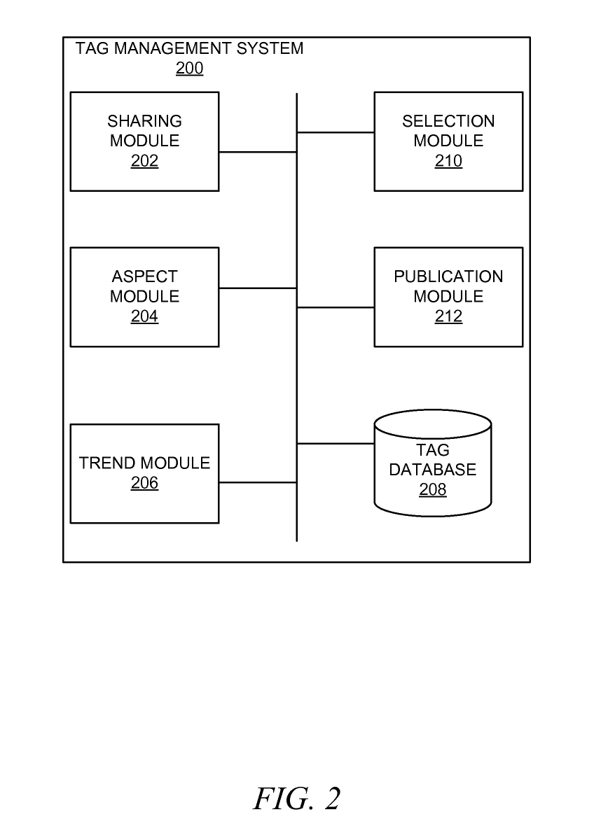

FIG. 2 is a block diagram of an example tag management system 200, according to various embodiments. The tag management system 200 may be implemented as part of the application servers 118 or by a third party server machine 130.

A sharing module 202 is configured to provide one or more share widgets at a webpage containing online content. The webpage may be a listing published by an online marketplace, a guide published by an online marketplace or online user, a webpage published by an online content provider, or content provided within a third party application. The share widgets, when selecting by the user via a graphical user interface, allow the user to eventually post a comment and a link to the webpage on a social network. Example share widgets include those that initiate sharing via one or more social networks such as LinkedIn, Pinterest, Instagram, Twitter, Facebook, and email.

In some instances, guides are generated by both the marketplace and by users of the marketplace. The webpage on which at least a portion of the guide is published may be shared by another user using a share widget. In other instances, virtual stores or storefronts generated a particular seller within the online marketplace to highlight that seller's good for sale may be shared using the share widget. In some instances, a user may feature one or more items listed for sale by a plurality of sellers as a “collection”. The collection itself or a profile page of the curator of the collection may be featured on a webpage and may be shared via a share widget. In some instances, a user of the online marketplace may allow a user to blog and link to the online marketplace. The webpage of the blog may include a share widget to allow sharing or the online marketplace may tag the blog or individual blog posts.

When a share widget is selected by a user, an aspect module 204 identifies a number of aspects of the online content. The aspects, in a listing published by an online marketplace may include, for example, various aspects (e.g., properties or characteristics) of the good, service, or proposed transaction such as brand, make, model, year, category, price (e.g., a current high bid, reserve price, or buy it now price), color, size, condition, sale type (e.g., auction or buy it now), seller, shipping availability and details, location, keywords, categories, product identifiers (e.g., UPC or ISBN code), seasonality, people, places, things, links, and images (pictures, GIFs, video, etc.).

In some embodiments, the aspect module 204 may pre-populate the online content with one or more metatags. The metatags are tags that are assigned to the online content by the content provider before the share widget is selected by the user. The metatags indicate one or more aspects of the online content that may be used to identify hashtags or keywords to append to the comments provided by the user.

Aspect module 204 ranks aspects identified from the online content according to popularity. In an online marketplace, popularity may be determined based on a frequency that the aspect appears in search queries, a frequency that use of the search term in a query results in a sale of the item, a frequency that use of the search term in a query results in a click-through to the online content from a search result page, a frequency that the aspect is included in a user profile of the members of the online marketplace, or a frequency that the aspect is included in one or more reviews of products or members of the marketplace.

In some instances, popularity is determined according to a frequency that the aspect appears in search queries. For example, the search queries may be based on data collected by a website (e.g., a search engine or online marketplace), search queries based on third party data or other data accessible from a third party agency. A social networking site may include a search box that allows users to query the inventory of an online marketplace. The queries may then be used even if they did not originate at the online marketplace. Another example may include running a program on a social networking site where the social network or agency is accessing the data of an online marketplace for users being targeted and then surfacing any related content if a user queries specific terms (such as “deals”). In another embodiment, an online marketplace may forge a relationship with a social network, where the social network reports a breakdown of keywords or phrases that users are submitting as queries or a frequency that use of the search term in a query results in a sale of the item.

While taking into account the different ways one could query or search as described above, the term “frequency” may refer to different keywords that users used to search and how that related to the purchase frequency of X product. For example, if someone who has done a lot of research on buying a specific product, like a Cartier handbag (e.g., the “Marcello de Cartier bag”), that person might type into eBay “Limited Edition Marcello de Cartier Tobacco colored cowhide medium model.” This query may lead to a higher probability of someone buying that bag because the person knew the full name of exactly what he was looking for and, therefore, those would be specific keywords may be used to lead to higher gross merchandise bought (GMB) value or purchasing frequency. Compare the behavior of someone that was just browsing and typed in “double C symbol shown on tan bag” which would result in simply browsing (e.g., traffic by a not-so serious buyer). By taking into account the type and frequency of queries used to define a product, this adds as a contributing factor to which types of keywords that are generated when a share widget is selected by another user.

Another way to look at the “frequency of the search term” relative to GMB is to identify the types of sites that traffic is coming from and how that corresponds to GMB. For example, a Cartier Handbag might perform best (generate the most GMB) with particular keywords on Pinterest.com, but different keywords on Twitter or even from a general search or even a blogger's site. The system may select the keywords that are actually populated based on the referral traffic's specific behaviour on the online marketplace site combined with the search behaviour on the previous site.

Alternatively, “frequency” may refer to a frequency that use of the search term in a query results in a click-through to the online content from a search result page. In these instances, a “search result page” may also include a simple search for keywords on a blogger's site, for example, someone searching for a Cartier handbag on fashionista.com, when a listing for an online marketplace's guide on buying handbags popped up that someone then clicked on (even if this isn't a formal search results page), we would want to account for this instance. Again, looking at the referral traffic—the effectiveness of different keywords may be measured based on data stored in the user's cookie. If a user visits pinterest.com and searches for #handbags and then that same user opens up another tab in their browser, typing in eBay (an online marketplace), then analysing that information may indicate that even if someone didn't click through, it is possible that by searching they saw something that came to mind, in which case they went directly to eBay as a result of that original query and search results that popped up.

“Frequency” may further refer to a frequency that the aspect is included in a user profile of the members of the online marketplace. For example, if someone loves handbags and indicates that he is a “handbag lover” in their Twitter bio, then the association between the user and “handbag” may be made. Alternatively, a user may follow (or be followed/friends with) “Cartier” on Twitter or like them on Facebook—in which case, when that user visits ebay.com to share out, the system would already have their social data and may use that data as a layer to populate the share widget. For example, the system may select the keyword “handbags” instead of the keyword “purse” like the view item page had already defined. Based on the user's social activity and once the system accesses social graph detailing the social network of the user, the system may identify kinds of products/information that the user is viewing or providing (e.g., content relating to a season, or mentions of a particular aspect over a period of time) and use that information to tag social sharing that that user or someone connected to the user would share on our site. Specifically, an online marketplace may access the user's profile on our own site for what they are interested in or access the user's behavior on a site. For example, if someone was looking at a page they wanted to share out, but because the system had previously stored what they had been searching for on the site, the system may use some of the keywords in their own query to define how the share widget is populated (obviously, case by case example).

In further embodiments, “frequency” refers to a frequency that the aspect is included in one or more reviews of products or members of the online marketplace.

Other types of scoring may be used instead of or in addition to frequency. For instance, if a guide for the Cartier bag is published by the online marketplace and 50 people gave it 5 stars for helpfulness, then the system may access the referral traffic. If it finds that a first “share” results in 100 people coming to the site for that guide, 50 of which left it 5 stars, then the keywords previously associated with the guide are effective. However, if a second share resulted in 100 people coming to the guide page and then clicking through to the Cartier suggested bag View Item page, then the system may take into account where the users went after they looked at the review, and add that second share information to the Cartier view item page that brought traffic to it.

By predicting what people want based on what their behavior is in search, it may be determined that when a search contains a certain person, brand or thing, they are actually looking for something else. For example, people who commonly search for the soccer player “Cristiano” on social networks may actually be looking for a signed Cristiano Ronaldo jersey or memorabilia to buy. Additionally, someone searching for “aviators” could indicate a search for pilots on a social network. However, through this method, the search for “#aviators” may indicate that one wanted “Ray Ban” “sunglasses” or “shades”. Therefore, it is possible there is a strong product affiliation between searching a simple, vague or ambiguous term and what the user is actually searching for. If someone submits a search including the phrase “cold remedies” rather than “tissues,” and ended up clicking through to Kleenex, then, based on that data, the share widget may be populated with tags with “cold remedies” instead of just “Kleenex” and “tissues”.

A final example is if a user has more general searching behavior. To illustrate, if someone came to a site and is looking at ten different pieces of equipment that are needed to play soccer. Later, the user decides to purchase and share a description of a set of shin guards. Based the user's search activity on the site to get to what they were looking for (e.g., different soccer products), then the system might create tags that say #soccergames or #supplies or “kidsgear” even if other shares were published with the tags “#soccer” “#shinguards” “#sports”.

In some instances, the determined popularity of a tag or keyword may be normalized. The normalization may be based on the popularity of other keywords, the popularity of the keyword over a previous period of time, the relative geographical popularity of the keyword, or other data. The normalization may be performed using one or more statistical methods such as mean, median, standard deviation, distribution, mode, or the like.

Based on the popularity of the aspects, the aspect module 204 identifies a pre-defined number of aspects used to select hashtags for the online content. The pre-defined number may be selected based on a desired length of the comment, a desired number of hashtags to be added to the comment, a relative popularity of the aspects, or other factors. In some instances, one to five aspects are identified.

A trend module 206 communicates via an API with the social network on which the online content is shared. The trend module 206 retrieves trend information from the social network. The trend information identifies the most popular hashtags or keywords published via the social network. Via the API, the trend module 206 may submit queries or otherwise access data, including previously published comments. If the trend module 206 submits queries, the queries may be generated based on a database of previously-used keywords, “trending” keywords, or some other source. In some instances, popularity is measured over a pre-defined period of time (e.g., in the last hour, last day, last week, last month, or last year). In other instances, the popularity of hashtags is not limited to the pre-defined period of time. For example, the popularity of the hashtags or keywords could be identified based on a specific segment of users that have posted or queried them.

The trend module 206 may access the trend information as the share widget is selected or on a pre-defined basis. The pre-defined basis may be a frequency such as once per hour, once per day, or once per week. In some instances, the pre-defined basis may differ based on one or more values of the aspects of the online content. For example, for the aspect “category”, the trend information for the value “video games” may be accessed more frequently than trend information for the value “home goods”. The trend information may be accessed for certain categories more frequently at various times. For example, tax-related trend information may be accessed more frequently during tax season (January through April) than at other times of the year.

A tag database 208 stores the trend information for a period of time after it is retrieved from the social network. The tag database 208 may store trend information retrieved from a plurality of social networks. In some instances, the tag database 208 may store one or more mappings describing known connections between one or more keywords and one or more tags.

A selection module 210 is configured to automatically, without human intervention, selects one or more tags (e.g., hashtags) to append to a comment that links to the online content. The aspects of the online content may be organized using data stores including, but not limited to, taxonomies, hierarchies, mapping, trees, nodes connected by edges, or the like. The organization connects an aspect to a tag retrieved from the social network. For example, an aspect within category, “yoga mat,” may be connected to the tags “#yoga” and “#fitness”. A descriptor, “Red Sox”, may be connected to the hashtags “#greenmonster”. Likewise, a brand like Michael Kors may be connected to the hashtags “#MK”.

When selecting tags, certain types of aspects may be favored. Types of aspects include, but are not limited to, brand, category, product identifier, seller, color, and influencer. An influencer is a person such as a celebrity or blogger who endorses, sponsors, or promotes the good or service described by the listing. For example, the selection module 208 may first identify aspects, and, in turn, tags, based on types of aspects like brand, then product identifier, then category. The selection module 208 may select the keywords to add based on the relative popularity of the aspects. In some instances, certain types of aspects or tags are prioritized over others. For example, tags related to brand may be prioritized over tags related to shipping options.

The tags may be selected by the selection module 210 using various methods including heuristic algorithms, statistical methods (e.g., supervised or unsupervised machine learning), or artificial intelligence. In an example embodiment, a multivariate regression model is followed to automatically select the tags. The multivariate regression model selects the combination of the tags appended to the comment based on one or more distinguishing attributes of the online content, the most popular tags on the social network, and a relative frequency and combination of related keywords or tags.

A publication module 212 is configured to generate a share interface. The share interface allows the user to provide at least a portion of a comment and includes the one or more selected tags and a link to the online content. The share interface includes an option to publish the user's comment, the selected tags, and the link on one or more social networks. The selected tags may form a portion of the comment and may be editable by the user prior to publication. In some instances, the selected tags are fixed by the provider of the online content or a publisher of the online content.

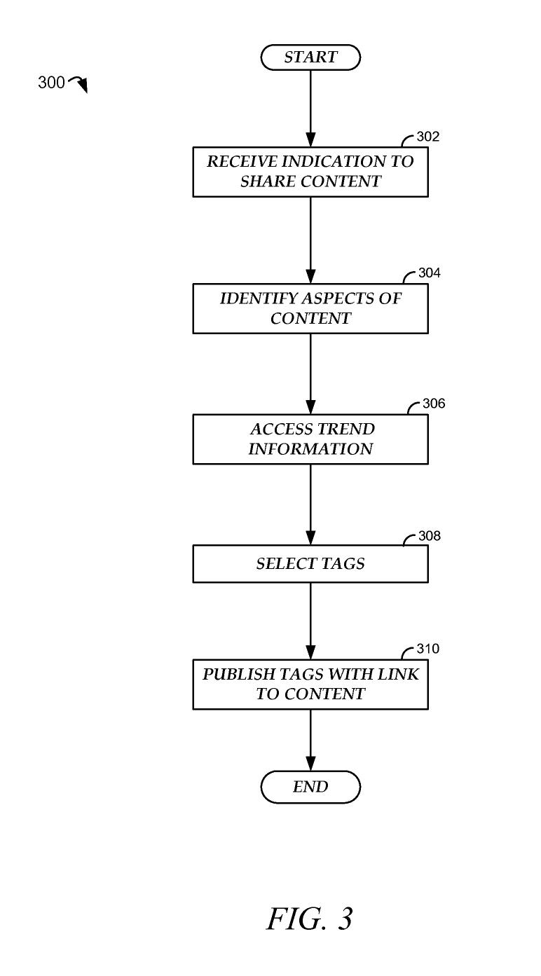

FIG. 3 is a flowchart illustrating an example method 300, according to various embodiments. The method 300 may be performed by the tag management system 200.

In an operation 302, an indication is received from a user that indicates intent to share electronic content using social media. The indication may be a selection of a share widget on a webpage or within an application. The electronic content may be published on the webpage or within the application. The indication identifies the social media entity where the content is to be shared. Part of the indication may include a comment provided by the user.

In an operation 304, aspects of the content are identified. The aspects may be identified based on keywords within the content, a categorization of the content, or a provider of the content. The aspects may be ranked based, for example, on relative popularity.

In an operation 306, trend information is accessed. The trend information may be stored and maintained by, for example, a content provider. The tag trend data indicates a relative popularity of tags within a social network. In some instances, the trend information indicates a period of time over which the trend information is determined.

In an operation 308, one or more tags are selected based on the content and the trend information. The tags may be selected by favouring certain types of tags. In some instances, combinations of tags may be selected.

In an operation 310, the selected tags are published to the social network with a link to the content. The tags may be published alongside a comment provided by the user. The social network may publish the tags and the link as a tweet, a pin, a status update, a comment, an image with a caption, or the like.

While embodiments described here are based, in part, on a listing published by an online marketplace, other embodiments may be used to connect keywords to other types of online content. Other online content, such as articles, blogs, graphics, videos, or audio content may have other characteristics such as publisher, author, identifier of content that the other content is based on, topic, cause, affiliation, or the like.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

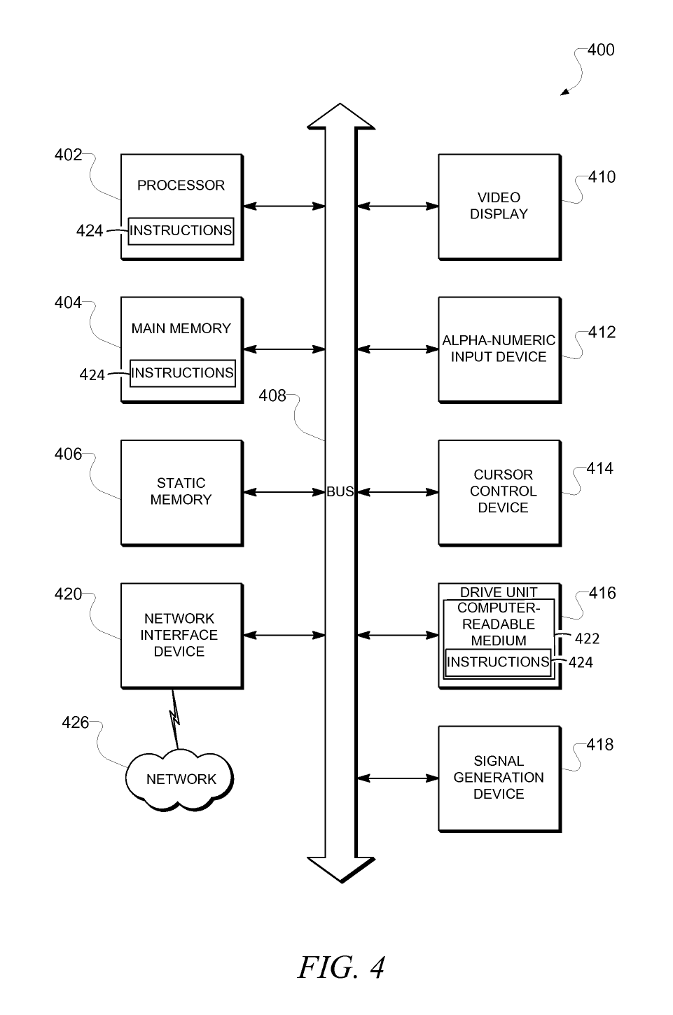

FIG. 4 is a block diagram of machine in the example form of a computer system 400 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 400 includes a processor 402 (e.g., a central processing unit (CPU), a graphics processing unit (GPU) or both), a main memory 404 and a static memory 406, which communicate with each other via a bus 408. The computer system 400 may further include a video display unit 410 (e.g., a liquid crystal display (LCD) or a cathode ray tube (CRT)). The computer system 400 also includes an alphanumeric input device 412 (e.g., a keyboard or a touch-sensitive display screen), a user interface (UI) navigation device 414 (e.g., a mouse), a disk drive unit 416, a signal generation device 418 (e.g., a speaker) and a network interface device 420.

### Machine-Readable Medium

The disk drive unit 416 includes a machine-readable medium 422 on which is stored one or more sets of instructions and data structures (e.g., software) 424 embodying or utilized by any one or more of the methodologies or functions described herein. The instructions 424 may also reside, completely or at least partially, within the main memory 404 and/or within the processor 402 during execution thereof by the computer system 400, the main memory 404 and the processor 402 also constituting machine-readable media.

While the machine-readable medium 422 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 424 may further be transmitted or received over a communications network 426 using a transmission medium. The instructions 424 may be transmitted using the network interface device 420 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A system comprising:
one or more processors;
a sharing module configured to receive an indication to share content via a social network;
an aspect module configured to identify one or more aspects of the content;
a trend module configured to access trend information, the trend information indicating one or more tags used to identify other content within the social network;
a selection module configured using the one or more processors and to select a portion of the one or more tags based on the identified one or more aspects of the content; and
a publication module configured to publish the selected portion of the one or more tags and a link to the content on the social network.

2. The system of claim 1, wherein the sharing module is configured to receive the indication via a share widget included in a webpage including the content.

3. The system of claim 1, wherein the sharing module is configured to receive the indication via a share widget included in an application providing the content.

4. The system of claim 1, wherein the aspect module is configured to pre-populate the content with one or more metatags indicating the one or more aspects of the content.

5. The system of claim 1, wherein the aspect module is configured to rank the one or more aspects.

6. The system of claim 5, wherein the aspect module is configured to select a pre-defined number of the aspects based on the rank of the respective aspects.

7. The system of claim 1, wherein the trend module is configured to access the trend information of the social network by submitting queries via an API.

8. The system of claim 1, wherein the trend information includes a popularity value assigned to the respective one or more tags.

9. The system of claim 8, wherein the popularity value is measured over a pre-defined period of time.

10. The system of claim 1, wherein the trend information corresponding to a particular category is accessed more frequently than the trend information corresponding to another category.

11. The system of claim 1, further comprising a tag database configured to store the trend information for a period of time.

12. The system of claim 11, wherein the tag database stores one or more mappings describing known connections between the one or more aspects and the one or more tags.

13. The system of claim 1, wherein the selection module is configured to organize the one or more aspects of the content according to a hierarchy.

14. The system of claim 1, wherein the selection module is configured to favor a certain type of aspect when selecting the portion of the one or more tags.

15. The system of claim 1, wherein the selection module is configured to select the portion of the one or more tags using a multivariate regression model.

16. The system of claim 1, wherein the publication module is configured to generate a share interface that allows a user to provide at least a portion of a comment and includes the selected portion of the one or more tags and a link to the content.

17. The system of claim 1, wherein the share interface is configured to allow a user to edit the selected portion of the one or more tags.

18. The system of claim 1, wherein at least a portion of the one or more tags are hashtags.

19. A method comprising:
receiving an indication to share content via a social network;
identifying one or more aspects of the content;
accessing trend information, the trend information indicating one or more tags used to identify other content within the social network;
using one or more processors, selecting a portion of the one or more tags based on the identified one or more aspects of the content; and
publishing the selected portion of the one or more tags and a link to the content on the social network.

20. A non-transitory computer-readable medium having instructions embodied thereon, the instructions executable by one or more processors to perform operations comprising:
receiving an indication to share content via a social network;
identifying one or more aspects of the content;
accessing trend information, the trend information indicating one or more tags used to identify other content within the social network;
using one or more processors, selecting a portion of the one or more tags based on the identified one or more aspects of the content; and
publishing the selected portion of the one or more tags and a link to the content on the social network.
